(19) United States
(12) Patent Application Publication
(10) Pub. No.: US 2009/0262518 A1
(43) Pub. Date: Oct. 22, 2009

(54) LIGHT GUIDING MECHANISM

(75) Inventor: Jin-Ti Cao, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/146,567

(22) Filed: Jun. 26, 2008

(30) Foreign Application Priority Data
Apr. 16, 2008 (CN) 200810301154.9

(51) Int. Cl. F21V 33/00

(52) U.S. Cl. 362/85

(57) ABSTRACT

A light guiding mechanism (20) for illuminating a keypad assembly of a portable electronic device is provided. The light guiding mechanism (20) includes a light guiding plate (22) and a plurality of shielding plates (24). The light guiding plate (22) has holes (28) defined therein. Each of the shielding plates (24) corresponds to one of the holes (28), and each of the shielding plates (24) is positioned over a surface of the light guiding plate (22) for shielding the respective holes (28).

### BACKGROUND

1. Field of the Invention

The present invention relates to light guiding mechanisms and, particularly to a light guiding mechanism used in portable electronic devices.

2. Description of Related Art

Portable electronic devices usually include keypads for inputting information. When operating such portable electronic devices in a dark room, keys of the keypads need to be illuminated to be seen and operated by users. Each key can be illuminated by a light source corresponding to the key. However, this type of keypad is expensive since a many light sources are required.

A typical way to reduce the number of light sources is to use a light guiding member in the form of a transparent plate. A typical light guiding member includes an array of apertures. As each key is arranged to align with the corresponding aperture, and the keys are illuminated by the light guided by the light guiding member. However, bright areas of the light guiding member may appear where the light sources are disposed adjacent to the light guiding member. Thus, there is decreased illumination uniformity of the light guide plate, which increases the difficulty of producing a desirable uniform illumination for the keypad.

Therefore, there is room for improvement within the art.

### BRIEF DESCRIPTION OF THE DRAWINGS

Many aspects of a light guiding mechanism can be better understood with reference to the following drawings. These drawings are not necessarily drawn to scale, the emphasis instead being placed upon clearly illustrating the principles of the present light guiding mechanism. Moreover, in the drawings like reference numerals designate corresponding parts throughout the several views. Wherever possible, the same reference numbers are used throughout the drawings to refer to the same or like elements of an embodiment.

FIG. 1 is an isometric and exploded schematic view of a light guiding mechanism in accordance with an exemplary embodiment.

FIG. 2 is an assembled view of the light guiding mechanism shown in FIG. 1.

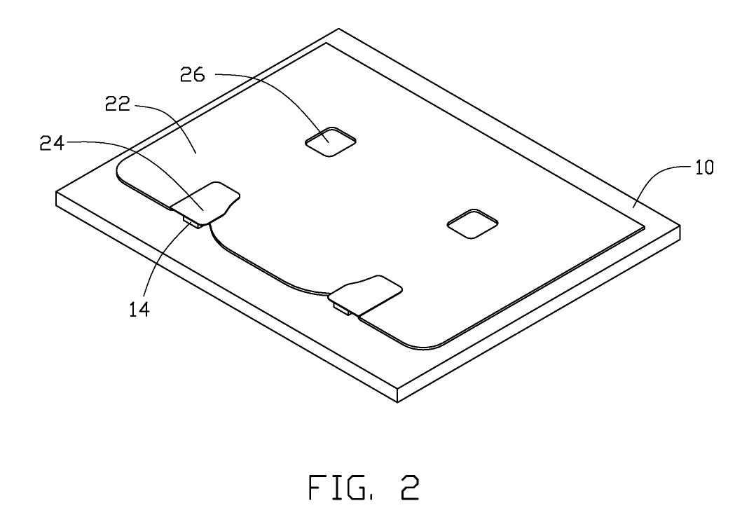

### DETAILED DESCRIPTION OF THE EXEMPLARY EMBODIMENTS

Embodiments will now be described in detail below and with reference to the drawings. The light guiding mechanism can be applied to an electronic device, for example, a mobile phone. Therefore, the light guiding mechanism is shown in the abstract, rather than associated with any particular electronic device.

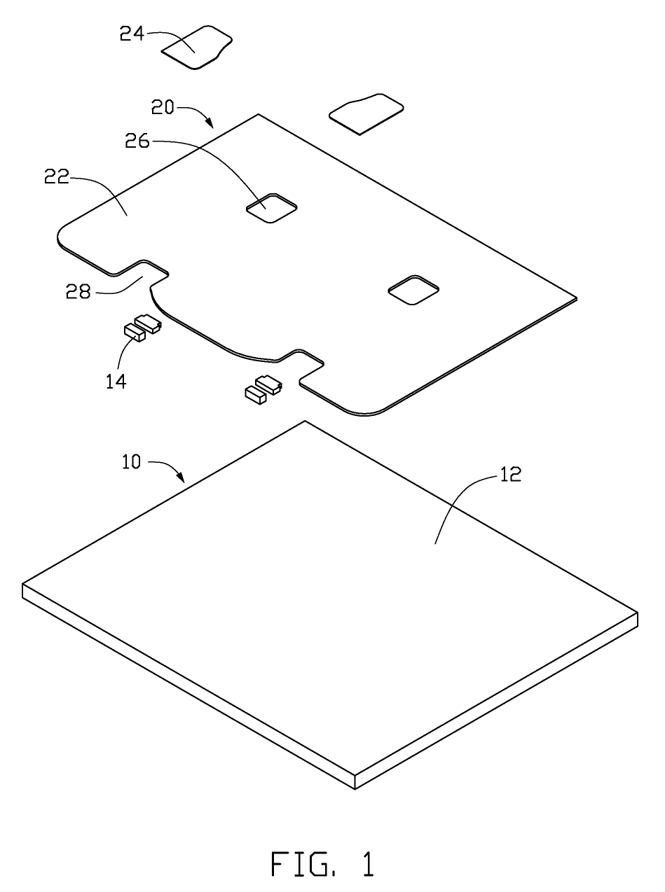

FIG. 1 shows a circuit board 10 and a light guiding mechanism 20. The light guiding mechanism 20 is disposed on the circuit board 10.

The circuit board 10 is generally rectangular and includes a surface 12 facing the light guiding mechanism 20. The circuit board 10 has a plurality of light sources 14 on its surface 12. The light sources 14 may be light emitting diodes (LEDs). When the light sources 14 are placed within the light guiding mechanism 20, light generated by the light sources 14 can be guided to illuminate keys of a keypad assembly (not shown).

The light guiding mechanism 20 includes a light guiding plate 22 and a plurality of shielding plates 24.

The light guiding plate 22 defines a plurality of first holes 26 and a plurality of cutouts 28 therethrough. The first holes 26 should correspond to and accommodate the keys of the keypad assembly. The light sources holes 28 should correspond to and accommodate the light sources 14. The light guiding plate 22 can be made of one or more materials selected from a group consisting of polyvinyl chloride (PVC), polycarbonate, polystyrene, and any other thermoplastic resins.

Each shielding plate 24 has substantially the same shape as of its corresponding second holes 28 but have a larger size than its corresponding second holes 28. The plurality of shielding plates 24 is disposed (e.g., bolted) on the light guiding plate 22 and configured for shielding the second holes 28. The shielding plates 24 can be made of various kinds of materials according to actual requirements. The shielding plate 24 can be made of an opaque material with a black color (e.g., the compound of resin and carbon) to prevent light penetration through the second holes 28. Conversely, the shielding plate 24 can be made of a semi-transparent material (e.g., a compound of resin and white metal) to allow light penetration through the second holes 28.

as the shielding plate 24 can be made from any material with any color, light passing through the second holes 28 can correspond to the color of the shielding plate 24.

An advantage of the exemplary embodiment is as follows. Brightness areas of the light guiding plate 22 usually appears where the light sources 14 are disposed adjacent to the light guiding plate 22. The plurality of shielding plates 24 are disposed on the light guiding plate 22 shielding the light sources 14 to eliminate the bright areas of the light guiding plate 22. Therefore, illumination uniformity of the light guide plate 22 is improved.

Another advantage of the exemplary embodiment is as follows. Light guided by the light guiding mechanism 20 can be provided with a certain color, which can be achieved by manufacturing the shielding plate 22 from a material having the desired color.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A light guiding mechanism, comprising:
a light guiding plate having a plurality of holes defined therein the holes configured for accommodating a plurality of light sources therein; and
a plurality of shielding plates, each shielding plate corresponding to one of the plurality of the holes, and each of the plurality of shielding plates positioned on a surface of the light guiding plate for shielding a corresponding light source, the shielding plates being made of a translucent material to allow light penetration through the holes.

2. (canceled)

3. The light guiding mechanism as claimed in claim 1, wherein the light guiding plate is transparent.

4. The light guiding mechanism as claimed in claim 3, wherein the light guiding plate is made of one or more thermoplastic resins selected from a group consisting of PVC (polyvinyl chloride), polycarbonate and polystyrene.

5. The light guiding mechanism as claimed in claim 1, wherein each of the plurality of the light sources is a LED.

6. (canceled)

7. (canceled)

8. (canceled)

9. The light guiding mechanism as claimed in claim 1, wherein the translucent material is a mixture of a resin and white metal.

10. The light guiding mechanism as claimed in claim 1, wherein the light source may be colored by using a plurality of shielding plates made of a material having the desired color.

11. A light guiding mechanism for illuminating a keypad assembly of a portable electronic device, comprising:
a light guiding plate having a plurality of holes defined therein, the holes configured for accommodating a plurality of light sources therein; and
a plurality of shielding plates respectively corresponding to the plurality of the holes, and each of the plurality of shielding plates formed on a surface of the light guiding plate for shielding the respective holes, the shielding plates being made of a translucent material to allow light penetration through the holes.

12. The light guiding mechanism as claimed in claim 11, wherein the plurality of shielding plates are attached to the light guiding plate.

13. The light guiding mechanism as claimed in claim 11, wherein the light guiding plate is transparent.

14. The light guiding mechanism as claimed in claim 13, wherein the light guiding plate is made of one or more thermoplastic resins selected from a group consisting of PVC (polyvinyl chloride), polycarbonate and polystyrene.

15. The light guiding mechanism as claimed in claim 11, wherein each of the plurality of the light sources is a LED.

16. (canceled)

17. (canceled)

18. (canceled)

19. The light guiding mechanism as claimed in claim 11, wherein the translucent is the mixture of resin and white metal.

20. The light guiding mechanism as claimed in claim 11, wherein the shielding plate is capable of made from any material with any color, light passing through the holes is capable of corresponding to the color of the shading plate.
